(19) United States
(12) Patent Application Publication
(10) Pub. No.: US 2023/0220843 A1
(43) Pub. Date: Jul. 13, 2023

(54) MONITORING AND CONTROLLING THE MONITORING OF VACUUM SYSTEMS

(71) Applicant: Edwards Limited, Burgess Hill, West Sussex (GB)

(72) Inventors: Ioannis Ioannides, Burgess Hill, West Sussex (GB); Christopher James Munnings Watts, Burgess Hill, West Sussex (GB); Brett Trevor Lawrence, Burgess Hill, West Sussex (GB)

(21) Appl. No.: 17/996,570

(22) PCT Filed: Apr. 22, 2021
(86) PCT No.: PCT/GB2021/050970

§ 371 Date: Oct. 19, 2022

(30) Foreign Application Priority Data
Apr. 23, 2020 (GB) 2005930.9

(51) Int. Cl. F04B 49/06; F04B 37/14; F04B 51/00

(52) U.S. Cl. CPC F04B 49/065; F04B 37/14; F04B 51/00

(57) ABSTRACT

A method of controlling monitoring of a vacuum system, the vacuum system, and the monitoring control system are disclosed. The method comprises: selecting at least one of a plurality of processes for monitoring the vacuum system from a data store storing the plurality of processes. Executing the at least one selected process Wherein one of the at least one selected processes comprises a process for monitoring a parameter of the vacuum system and for responding to changes in the parameter to trigger at least one of: execution of a further one of the plurality of processes; output of an alarm or notification signal; and output of a control signal for controlling operation of at least one component of the vacuum system.

### CROSS-REFERENCE OF RELATED APPLICATION

This application is a Section 371 National Stage Application of International Application No. PCT/GB2021/050970, filed Apr. 22, 2021, and published as WO 2021/214468A1 on Oct. 28, 2021, the content of which is hereby incorporated by reference in its entirety and which claims priority of British Application No. 2005930.9, filed Apr. 23, 2020.

### FIELD

The field of the invention relates to methods and systems for monitoring vacuum systems and for controlling the monitoring of vacuum systems.

### BACKGROUND

Vacuum systems such as abatement systems used in semiconductor processing are expensive systems, and shutting the system down to service any of the many components can be very expensive. This is particularly so where the shutdown is due to a fault and is therefore not planned.

Many components of vacuum systems such as vacuum pumps and abatement units have sensors associated with them for monitoring their operation. These sensors allow some monitoring of the operation of these individual units, however, an overall view of the operation of the whole system is harder to achieve. Furthermore, many systems are bespoke systems and understanding the significance of the data from the different sensors may not be trivial and may require considerable experience and expertise.

It would be desirable to be able to provide a system able to provide effective monitoring and/or effective control of the monitoring of a vacuum system.

The discussion above is merely provided for general background information and is not intended to be used as an aid in determining the scope of the claimed subject matter. The claimed subject matter is not limited to implementations that solve any or all disadvantages noted in the background.

### SUMMARY

A first aspect provides, a method of controlling monitoring of a vacuum system, said method comprising: selecting at least one of a plurality of processes for monitoring said vacuum system from a data store storing said plurality of processes; and executing said at least one selected process; wherein

one of said at least one selected processes comprises a process for monitoring a parameter of said vacuum system and for responding to changes in said parameter by triggering at least one of: execution of a further one of said plurality of processes; output of an alarm or notification signal; and output of a control signal for controlling operation of at least one component of said vacuum system.

The inventors of the present invention recognised that service engineers that service different vacuum systems accumulate a lot of experience and knowledge of how variations in parameters sensed by sensors within components of the vacuum system may affect not only the operation of that particular component but also the operation of the whole system. They also recognised that being able to apply such knowledge to an automatic monitoring system that is appropriate for different bespoke vacuum systems can be challenging, but that the ability to diagnose or predict faults within such a vacuum system is highly valuable.

They have addressed these problems by providing a method of controlling the monitoring of a vacuum system that can be tailored to a particular vacuum system by allowing the control system to select from a plurality of different processes that are stored and are available and suitable for monitoring vacuum systems. Thus, the monitoring method can select and execute one or more particular processes at one or more particular times to perform a desired set of monitoring operations appropriate to that vacuum system. Execution of these processes may trigger one or more of: further monitoring processes, notifications, alarms or control signals, these being triggered in response to the results of the monitoring.

By making a plurality of different processes available and providing a method that selects and executes these processes, tailored monitoring can be provided in a manner that is easy to adapt to new systems and to changes made in existing systems. Furthermore, this modular way of executing selected processes at selected times allows the amount of processing power used to be constrained to within a desired limit. It also allows different portions of the monitoring method to be updated without the requirement to halt the entire monitoring process where this is required perhaps in response to changes in circumstances or advances in an engineer's knowledge.

In some embodiments, at least some of said plurality of processes stored within said data store comprise one or more of:
a process for monitoring a parameter of said vacuum system;
a process for monitoring at least one of: a value and rate of change of a value output by at least one sensor sensing a parameter of said vacuum system;
a process for comparing a value output by at least one sensor sensing a parameter of said vacuum system to a threshold value; and
a process for performing a predefined mathematical function on at least one parameter sensed by a sensor in said vacuum system; and
a process for adjusting a threshold at which to respond to changes in said parameter in dependence upon data from previously executed processes; and
a process for triggering an alarm, notification or control signal.

The processes for monitoring the vacuum system that are stored in the data store, may each be composed of one or more different process steps, many of which may be based on standard monitoring process steps. The monitoring method controls the selection and execution of these processes. As knowledge is gained by service engineers and/or as systems are changed and/or updated, the changes and additional knowledge can be reflected in the monitoring system by one or more of: updating the monitoring processes within the data store and changing the monitoring processes that are selected. This may be done by at least one of: updating threshold values within the processes, changing the timings of the execution of the processes, changing the mathematical functions that are used for analysis within the processes and adding new processes that may sense further or different parameters. In this way the ability to form tailored monitoring processes from basic and possibly standard process steps or blocks is provided without the need for specialised software expertise.

Examples of monitoring process steps that may form part or all of one of the processes for selection include the following:

The monitoring of a parameter of the vacuum system. This may involve requesting the parameter from a data interface. The requested parameter may be a current value of the parameter or it may be one or more historic values of that parameter. The parameter may be a sensed value output by a sensor within the vacuum system or it may be a value output by a counter indicating how many times the vacuum system has performed some function, or it may be an indication of when a particular component was changed or some other information regarding the system.

The monitoring of the rate of change of a value output by one or more of the sensors sensing a parameter within the vacuum system.

The comparing of a value output by at least one sensor to a threshold value. In this regard, an engineer with knowledge of a particular system may know that if the pressure in the system rises above a certain value, perhaps within a certain time frame, or if the trend in the pressure is increasing at more than a certain rate when a threshold is passed then perhaps this is an indication that there is something wrong with the system such as an exhaust being blocked. Thus, using monitoring processes that can take the value of a sensor and compare it to a threshold or take the rate of a change of a value and use that allows the system to trigger notifications, alarms or indeed to control the system to shut down if appropriate. Furthermore, the threshold values can be changed with increased knowledge or changes in the vacuum system as appropriate.

The performing of a predetermined mathematical function on at least one parameter sensed by a sensor in the vacuum system. Knowledge of the system and previous analysis from data may show that certain predefined mathematical functions applied to the data provide good indicators of certain fault conditions and thus, processes that apply particular mathematical functions to certain parameters can be useful in triggering appropriate alarms or notifications or indeed triggering other monitoring processes to start.

The adjusting of a threshold at which to respond to changes in a parameter, in dependence upon data from previously executed processes. In this regard, as data is being collected over time from various sensors, this historic data may be used to further hone the analysis. For example it may be recognised that although passing a certain threshold value intermittently may not be an indication of a fault, if this occurs a certain number of times within a certain time frame or at a certain point in the operation of the vacuum system then this may be an indication of some fault condition which it would be desirable to indicate to an operator. Thus, this certain threshold may be used as a new threshold value in the process when these other conditions have been met.

In some embodiments, said step of selecting comprises one of:
periodically selecting at least one of said processes for execution from said data store;
selecting at least one of said processes for execution from said data store in response to an output of an executed process; and
selecting at least one of said processes for execution in response to an input from a user.

The control of monitoring is such that different processes can be selected for execution depending on a number of factors and may be selected for execution either in parallel with each other or at different times. For example, a process may be selected periodically to provide periodic monitoring of particular parameters to detect any deterioration over time in portions of the vacuum system. The periodic nature of the monitoring may vary depending on different factors such as the process being executed and/or the age of the vacuum system. Alternatively and/or additionally a process may be selected in accordance with a user's request where for example a user may want to perform a particular check on the vacuum system where perhaps he believes there may be a fault or where he wishes to know if servicing is required. Alternatively and/or additionally a previous process may trigger execution of a subsequent process, for example where one process determines that some parameter has exceeded a threshold value then further monitoring of some other related value may be triggered. In this way, control of the monitoring of the vacuum system can be done in adaptable ways which allow efficient use of the processing resources and further allows appropriate selection of monitoring processes to be performed depending on circumstances and the vacuum system being monitored.

In some embodiments, said step of selecting comprises:
periodically selecting one of said plurality of processes for execution every predetermined first period;
periodically selecting another of said plurality of processes for execution plurality of processes for execution every predetermined second period, said predetermined second period being different to said predetermined first period.

Where some processes are selected periodically, it may be that it is advantageous if some of the processes are performed quite often, say once every few hours, whereas others may only be required to be performed less often for example once a week. The system is configured to be able to periodically select different processes for different periods of time such that the appropriate processes can be applied with an appropriate frequency as required. This has the advantage that the amount of processing capacity used can be limited by executing processes in series as well as in parallel where this is appropriate.

In some embodiments, said parameters comprise at least one of: temperature;
flow rate; vibrations; counter values; pressure; and power.

The parameters that are monitored are parameters indicative of the operation of the vacuum system and these may comprise different things including temperature, pressure, flow rate, counter values, vibrations and power. In this regard, vibrations and power use are indicative of wear in the system, counter values may indicate how many times certain events have happened or when certain components have been serviced or exchanged and temperature, flow rates and pressure may be indicative of blockages in the system or more general faults.

In some embodiments, the method comprises in response to determining execution of one of said processes failing, terminating operation of said process.

The modular nature of this method allows processes that have some fault associated with them and that do not execute correctly to be terminated without the whole monitoring system failing. This provides an adaptable and flexibly robust system.

In some embodiments, following terminating of said operation of said process deleting said process from said data store.

It may be advantageous to delete the process that did not execute correctly and thereby impede it from inhibiting monitoring of the vacuum system in future. A notification may be provided to a user that this process has been deleted from the system.

In some embodiments, the method comprises storing data determined from execution of said process in a data store.

The data that is collected from the sensors during the monitoring processes may be stored for use either as a source of data when analysing the vacuum system to improve processes later or for use as historic data in some of the monitoring processes. In some embodiments the data store is provided in a data interface between the vacuum system and the monitoring control system.

In some embodiments, the method comprises periodically storing said process to said data store at preselected points during execution of said process.

It may advantageous if the process is periodically stored at preselected points during execution of the process to enable the process to be restarted at an appropriate point were the system to fail for some reason. These preselected points may be points indicated within the process itself.

In some embodiments, said step of selecting comprises uploading said process for execution from said data store and decrypting said process prior to said execution.

The processes may be encrypted within the data store and the step of selecting may include uploading the processes and decrypting them prior to execution. When these processes are uploaded for execution they may be decoded and stored in a cache within a control system for controlling the monitoring method. When the process has completed the application is deleted from the cache.

Where the data is encoded within the data store then the process of storing the process to the data store may comprise encrypting the process prior to storing it. In this way, processes may be stored in an encrypted form to protect them, while decoding resources associated with the control system controlling the monitoring allow them to be executed. Processes may be stored to the data store along with their data at preselected points during execution allowing them to be restarted at these points if there is some interruption of the monitoring.

In some embodiments, the method comprises a further step of at least one of adding, updating or deleting at least one process from said data store.

One advantage of this modular system is that the different processes for monitoring are executed independently of each other and are stored in an associated data store. This allows these processes to be updated, amended, new processes added and/or existing processes deleted in a way that does not interfere with the execution of the monitoring system. This is a considerable advantage of this present system. Furthermore, as the processes may be formed from standard blocks controlling steps such as steps for requesting parameters, comparing parameters with threshold values, performing mathematical functions on parameters etc., new processes can be generated and added to the data store without the requirement for particular expertise in the software associated with the monitoring control system itself.

A second aspect provides a computer program comprising a plurality of computer executable instructions which when executed by a processor are operable to control said computer to perform a method according to a first aspect.

A third aspect comprises a control system for controlling the monitoring of at least one vacuum system, said control system comprising: a processor; and
a data store associated with said processor, said data store storing said computer program according to a second aspect.

In some embodiments, the control system further comprises a further data store storing a plurality of applications each comprising a plurality of computer executable instructions, said plurality of applications being operable when executed by said processor to control said processor to perform a corresponding plurality of monitoring processes, at least some of said plurality of monitoring processes comprising one or more of:
a process for monitoring a parameter of said vacuum system;
a process for monitoring at least one of: a value and rate of change of a value output by at least one sensor sensing a parameter of said vacuum system;
a process for comparing a value output by at least one sensor sensing a parameter of said vacuum system to a threshold value; and
a process for performing a predefined mathematical function on at least one parameter sensed by a sensor in said vacuum sensor;

a process for adjusting a threshold at which to respond to changes in said parameter in dependence upon data from previously executed processes; and
a process for triggering an alarm, notification or control signal.

The processes stored within the data store may be applications comprising computer executable instructions which applications may be uploaded for execution when selected by the monitoring control system.

A fourth aspect provides a vacuum system comprising at least one of: a vacuum pump and an abatement unit, a plurality of sensors, a data interface for receiving and storing data from said plurality of sensors, and a control system according to a third aspect.

Vacuum systems comprising vacuum pumps and/or abatement units generally have sensors associated with them for monitoring operation of the components and data from these sensors can be collected and monitored to provide an overall diagnosis or prognosis of the operation of the system. Where it is costly to service and shut down the system such diagnosis and indeed prognosis can be extremely helpful. In particular, such monitoring may indicate where a service is required and/or where perhaps a scheduled service may not be needed allowing the system to operate for a longer period without shut down. In some cases, the data interface and monitoring system may be used for monitoring a plurality of vacuum systems.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 schematically shows a monitoring control system, data store and vacuum system according to an embodiment;

FIG. 2 schematically shows a monitoring control system selecting and executing processes from a data store according to an embodiment;

FIG. 3 schematically shows a monitoring control system determining a process is corrupt and deleting the corrupt process;

FIG. 4 schematically shows a monitoring control system, data store and vacuum system according to an embodiment; and

FIG. 5 schematically shows a method of monitoring a vacuum system according to an embodiment.

### DETAILED DESCRIPTION

Before discussing the embodiments in any more detail, first an overview will be provided.

The monitoring control system in some embodiments formed as a Smart Rules Engine is a lightweight workflow engine that uses re-usable building blocks to build diagnostic/prognostic models for vacuum and abatement equipment.

The Smart Rules Engine uses a data interface to communicate with the vacuum system. The smart rules engine controls monitoring of the vacuum system to analyse pump and abatement parameters to output information to a User Interface to allow for better servicing and understanding of the state of a system. Furthermore, it provides diagnostics/prognostics that can be understood and updated by non-software developers allowing the domain knowledge from users such as service engineers to be included in the monitoring of the system.

In some embodiments the smart rules engine can start and stop models or processes both locally and remotely. It is able to run models against different time intervals, e.g.: once a day, once a month or all the time. In addition, in some embodiments it can read and run encrypted and un-encrypted models. In order to protect itself, it can identify broken models and remove them from the system without adversely impacting the system or other running models.

The models or processes make use of built-in and custom blocks that may comprise graphical and business logic layers. The graphical interface component allows for more understandable communication between technical and non-technical persons. These blocks can be written to perform any task, e.g.: requesting data from a remote or local source or performing advanced mathematical functions. These blocks may involve the manipulation of data utilising domain knowledge to provide information to users about the state of the system.

Embodiments provide a monitoring control system that allows or provides: efficient CPU performance, smart management of model execution, dynamic deployment, data-input flexibility, custom creation In embodiments, the monitoring control system is formed as a modular computer program that can be expanded for use with new products without any major software re-engineering. Indeed embodiments allow new models to be provided to the data store and then selected, uploaded and executed without the need to restart the system.

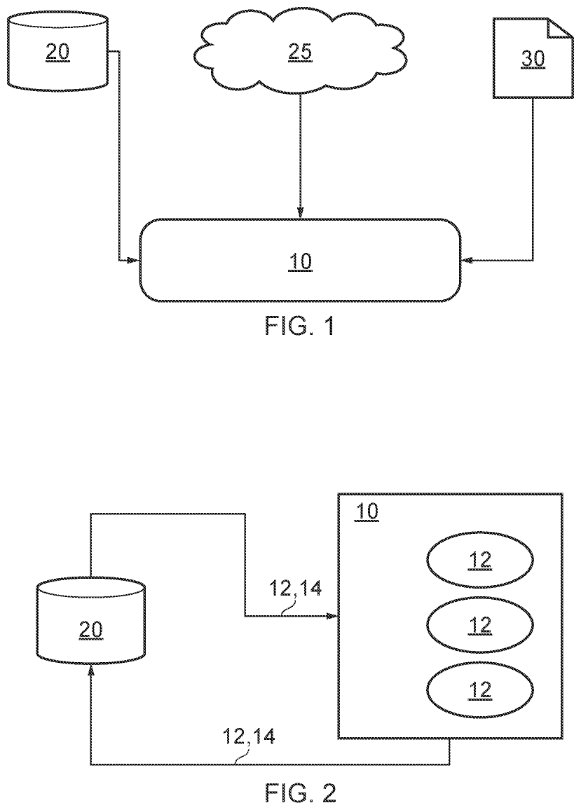

FIG. 1 schematically shows a monitoring control system 10, data store 20 and vacuum system 30 according to an embodiment. The monitoring control system 10 is connected to a data store 20 which stores a plurality of processes or models for monitoring an integrated vacuum system 30. The monitoring control system 10 selects processes in the form of applications stored in the data store, uploads them from the data store, decrypts them and then executes them as required. During execution the processes acquires and processes data output from the vacuum system 30. The data may be received directly from the vacuum system or via a data interface (not shown). Alternatively, they may come via the web 25 which acquires data from different sources as required by the monitoring system.

When the monitoring control system 10 has finished executing a particular application it may encode it and store it back to the data store 20. In some embodiments, personnel may have access to the data store such that they can add, delete or amend applications within the data store. This allows threshold values to be updated for example or different mathematical functions to be performed.

FIG. 2 schematically shows how the monitoring control system 10 may execute a plurality of processes 12 in parallel and how these can be uploaded from data store 20 and stored back to data store 20 in some cases along with the data that the models generate. These processes 12 and data 14 associated with them may be uploaded from the data store 20 and executed by a processor on the monitoring control system 10.

In some embodiments the processes are stored in encrypted form in the data store 20 and the monitoring control system 10 encrypts or decrypts the processes when storing or uploading the processes to the data store 20. In some embodiments, the processes 12 and associated data 14 may be stored at preselected points during execution such that data is not lost if there is an interruption of service. Furthermore, where a process is configured to run periodically it may be downloaded to the data store between executions and then re-uploaded.

The ability to store these different models or processes enables scalability, recovery in the face of failure and the ability to manage both the processor and memory more efficiently.

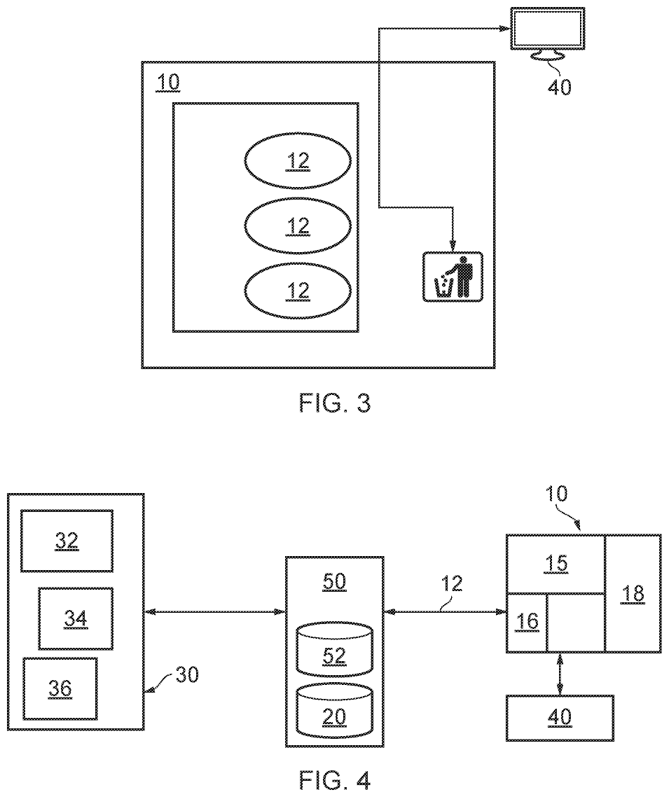

FIG. 3 schematically shows how this system is also adept at managing failure of a particular process 12. Thus, in this example one of the models/processes 12 running within the monitoring control system 10 fails and this process is stopped and deleted from the monitoring control system and is also deleted from the data store 20. A message may be sent to a user interface 40 to notify the user of the failure of the process.

FIG. 4 schematically shows the vacuum system 30, data interface 20 and monitoring control system 10 of an embodiment. In this example vacuum system 30 comprises an abatement unit 32 and two vacuum pumps 34 and 36. Each of these different components comprise a number of sensors each of which output sensed data to data interface 50. These sensors may include pressure, temperature, flow rate and vibration sensors. They may also include power sensors for sensing the amount of power required to drive motors within the system and counters for counting the number of times a certain function has been performed since the component was installed or since the component was serviced. There may also be a timer to indicate the time elapsed since a previous service and/or counters to count of number of times certain thresholds have been exceeded.

Data interface 50 is an interface that receives data from one or more vacuum systems and stores the data in data store 52. Data interface also comprises, in this embodiment data store 20 that stores the processes in the form of computer applications that the monitoring control system can select for execution.

Monitoring control system 10 is linked to the data interface 50 and selects applications from data store 20 for executing on processor 18. When executing the processes the monitoring control system may request data from data store 52 within data interface 50 as required by the processes.

In operation monitoring control system 10 requests one or more applications from data store 20, and decodes the uploaded application using encoder/decoder 16 and stores the decoded application in cache 15. Processor 18 then executes the process and may generate notifications or alarms that are output to user interface 40 and/or it may trigger execution of a further process. Where that process has already been uploaded to monitoring control system 10 then that is executed by processor 18. Where the application is not within the monitoring control system 10 then it is requested from data store 20 and uploaded, decoded and executed. Once a process has completed execution then it is removed from cache 15. Data generated during execution of the process may used to trigger an alarm or process, and/or some or all of it may be stored to data store 52. If during execution the process is determined to be corrupt then it may be removed from the cache 15 and deleted from data store 20 and a warning to this effect output to interface 40.

In some embodiments, the monitoring system may only monitor and may not control the vacuum system, while in other embodiments the monitoring system may trigger a control signal to be sent back via data interface 50 to vacuum system 30 to stop operation or slow down operation of one or more of the components in response to the monitoring system detecting that some parameter is approaching a critical level.

Examples of the processes executed by processor 18 include the monitoring of parameters, the comparison of parameters and/or rate of change of parameters with threshold values, the triggering of alarms or notifications or the triggering of execution of one or more further processes, the application of a particular mathematical method to analyse changes in parameters. One or more of these different processes may be used to diagnose the condition of the vacuum system and/or to perform prognosis of future problems. This may enable servicing to be scheduled and/or rescheduled as required and it may also enable catastrophic failures to be inhibited.

The modular nature of this system enables applications within data store 20 to be generated and updated individually while other applications are still executing or are available for execution. Furthermore, as they are formed of simple process steps which are straightforward to encode and for which encoding blocks are available they can be updated and amended without the requirement for a skilled software engineer. Thus, as the vacuum systems 30 are amended with new or additional equipment and/or as service engineers discover more information regarding the operation of the vacuum system this can be included within the processes or models stored in data store 20 and the monitoring/diagnosis and prognosis of the vacuum system can be improved.

The domain logic used within the blocks is in effect reusable and the rules can be updated as required. Furthermore, as this is a modular system the amount of processing power required is both limited and controllable, by controlling the number of modules being executed at any one time. Furthermore, the system can be controlled remotely.

A user can interact with the system 10 via interface 40 to request certain processes to be performed and to start and stop the monitoring as well as to receive notifications.

The data interface 50 stores data from the vacuum system 30 and this data can be used for analysis and to help in the predictions of future system operation and thus in the updates of the processes stored in data store 20.

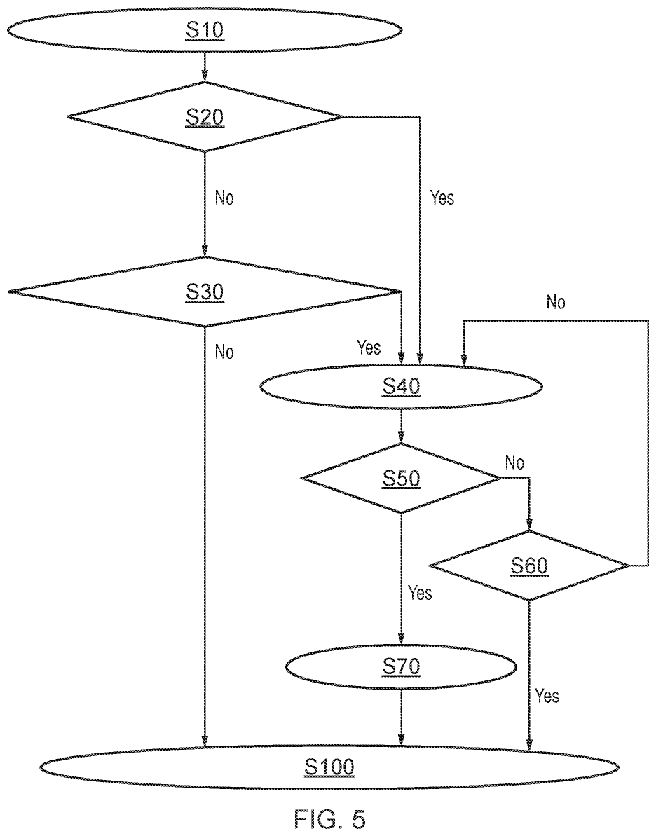

FIG. 5 shows a flow diagram schematically illustrating steps performed by the monitoring control system 10 of an embodiment when it is executing one of the processes. The first step within the process is to request the temperature at the pump inlet and this is performed in step S10. In step S20 the temperature is compared to a threshold value and if it is determined that it is not above the threshold then at step S30 the rate of temperature increase is determined to see if that is above a threshold. If neither are above a threshold then at S100 this process ends. This process will be repeated again at a later point as it is a process performed periodically to check that the inlet to the system is not blocked.

If at step S20 the temperature is determined to be above the threshold or if at step S30 the rate of temperature increase is determined to be above a threshold then step S40 is performed where the pressure at the pump inlet is requested. If this is determined to be above a pressure threshold at step S50 then an inlet block alert is triggered at step S70 and this will be displayed on the user interface 40. The process is then ended and the user may perform whatever steps are required to address this.

If at step S50 it is determined that the pressure threshold is not exceeded then it is checked how many times this pressure has been checked. This is performed by checking the output of a counter at step S60 and if the pressure check has not been performed three times then the pressure at the inlet is again requested after a predetermined time delay to determine if it has risen above the pressure threshold. If the counter indicates that the pressure has been checked three times then the process is ended.

This example process allows a temperature rise, or rate of temperature rise, that is above a threshold to be detected and to trigger a pressure check over a time period. This allows the monitoring system to both detect an unexpected increase in temperature and to determine whether the rise in temperature is due to a pressure increase which may indicate a blocked inlet. If no temperature increase is detected or if after a predetermined time it is determined that the pressure is not unduly high then the process can be stopped. In some cases where there was a temperature rise but no increase in pressure, a further process may be triggered to determine perhaps if vibration levels have risen above a certain level to check that the temperature is not rising for some other reason such as motor wear.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A method of controlling monitoring of a vacuum system, said method comprising:
selecting at least one of a plurality of processes for monitoring said vacuum system from a data store storing said plurality of processes; and
executing said at least one selected process; wherein
one of said at least one selected processes comprises a process for monitoring a parameter of said vacuum system and for responding to changes in said parameter to trigger
execution of a further one of said plurality of processes.

2. The method according to claim 1, wherein
at least some of said plurality of processes stored within said data store comprise one or more of:
a process for monitoring a parameter of said vacuum system;
a process for monitoring at least one of: a value and rate of change of a value output by at least one sensor sensing a parameter of said vacuum system;
a process for comparing a value output by at least one sensor sensing a parameter of said vacuum system to a threshold value; and
a process for performing a predefined mathematical function on at least one parameter sensed by a sensor in said vacuum system; and
a process for adjusting a threshold at which to respond to changes in said parameter in dependence upon data from previously executed processes; and
a process for triggering an alarm, notification or control signal.

3. The method according to claim 1, wherein said process of monitoring a parameter of said vacuum system comprises requesting said parameter from a data interface, said parameter requested comprising at least one of a current value of said parameter and one or more historic values of said parameter.

4. The method according to claim 1, wherein said step of selecting comprises one of:
periodically selecting at least one of said processes for execution from said data store;
selecting at least one of said processes for execution from said data store in response to an output of an executed process; and
selecting at least one of said processes for execution in response to an input from a user.

5. The method according to claim 4, wherein said step of selecting comprises:
periodically selecting one of said plurality of processes for execution every predetermined first period;
periodically selecting another of said plurality of processes for execution plurality of processes for execution every predetermined second period, said predetermined second period being different to said predetermined first period.

6. The method according to claim 1, wherein said parameters comprise at least one of:
temperature;
flow rate;
vibrations;
counter values;
pressure; and
power.

7. The method according to claim 1, comprising in response to determining execution of one of said processes failing, terminating operation of said process.

8. The method according to claim 7, comprising following terminating of said operation of said process deleting said process from said data store.

9. The method according to claim 1, comprising storing data determined from execution of said process in a further data store.

10. The method according to claim 1, comprising periodically storing said process to said data store at preselected points during execution of said process.

11. The method according to claim 1, wherein said step of selecting comprises uploading said process for execution from said data store and decrypting said process prior to said execution.

12. The method according to claim 10, comprising encrypting said process prior to storing said process to said data store.

13. The method according to claim 1, comprising a further step of at least one of adding, updating or deleting at least one process from said data store.

14. (canceled)

15. A control system for controlling the monitoring of at least one vacuum system, said control system comprising:
a processor; and
a data store associated with said processor storing a computer program comprising a plurality of computer-executable instructions which when executed by the processor are operable to perform the method of claim 1.

16. The control system according to claim 15, further comprising
a data store storing a plurality of applications each comprising a plurality of computer executable instructions operable when executed by said processor to control said processor to perform a corresponding plurality of monitoring processes, at least some of said plurality of monitoring processes comprising one or more of:
a process for monitoring a parameter of said vacuum system;
a process for monitoring at least one of: a value and rate of change of a value output by at least one sensor sensing a parameter of said vacuum system;
a process for comparing a value output by at least one sensor sensing a parameter of said vacuum system to a threshold value; and
a process for performing a predefined mathematical function on at least one parameter sensed by a sensor in said vacuum sensor;
a process for adjusting a threshold at which to respond to changes in said parameter in dependence upon data from previously executed processes; and
a process for triggering an alarm, notification or control signal.

17. A vacuum system comprising:
the control system according to claim 15 for controlling the monitoring of said vacuum system;
at least one of: a vacuum pump and an abatement unit;
a plurality of sensors; and
a data interface for receiving and storing data from said plurality of sensors.

18. A plurality of vacuum systems each comprising:
the control system according to claim 15 for controlling the monitoring of said plurality of vacuum systems;
at least one of: a vacuum pump and an abatement unit;
a plurality of sensors; and
a data interface for receiving and storing data from said plurality of sensors of each of said vacuum systems.

19. A method according to claim 1, wherein said process for monitoring a parameter of said vacuum system and for responding to changes in said parameter further triggers at least one of:
output of an alarm or notification signal; and
output of a control signal for controlling operation of at least one component of said vacuum system.
